(19) United States
(12) Patent Application Publication
(10) Pub. No.: US 2006/0274920 A1
(43) Pub. Date: Dec. 7, 2006

(54) Personal identification device and system having personal identification device

(76) Inventors: Osamu Tochikubo, Kanagawa (JP); Masamichi Torigai, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/560,380

(22) PCT Filed: Jun. 9, 2004
(86) PCT No.: PCT/JP04/08039

§ 371 Date: Dec. 13, 2005

(30) Foreign Application Priority Data
Jun. 16, 2003 (JP) 2003-170866

(51) Int. Cl. G05B 19/00

(52) U.S. Cl. 382/124; 340/5.53; 340/5.83

(57) ABSTRACT

A personal identification device 1 comprises a fingerprint sensor 1a that detects a fingerprint; and a scanner 1b that calls a storage medium 2 mounted on a portable device 3 worn on a finger, a wrist, or an ankle of a user for reading recording information stored on the storage medium 2. The fingerprint sensor and the scanner are integrally provided in a device main body of the personal identification device. The personal identification device further comprises fingerprint comparison means 1c for comparing fingerprint data of a user's finger detected by the fingerprint sensor 1a with fingerprint comparison data read by the scanner 1b from the storage medium 2 of the portable device 3 worn on the finger or the wrist of the user. The fingerprint comparison means 1c identifies that the holder of the storage medium is an authentic user based on a match between the fingerprint data and the fingerprint comparison data.

### TECHNICAL FIELD

The present invention relates to a personal identification device for identifying a person's identity and a system for allowing the user to perform a predetermined operation based on the personal identification.

### BACKGROUND ART

Various methods are known for identifying a person, for example, a biometric method in which biological properties such as person's fingerprints, irises, retinas, facial characteristics, and hand vein patterns are used and a method in which an identification code is recorded on a storage medium such as a magnetic card or an IC card.

A device, which is based on the biometric method utilizing biological properties, uses a sensor to detect biological data, compares the detected data with pre-registered data and, if they match, identifies person's identity. Because biological data depends on individuals and measurement conditions, it is difficult for this identification device to attain high detection accuracy and therefore a high-accuracy sensor is required to increase detection accuracy. In addition, because a large amount of biological data must be registered for comparison, biological data must be recorded on a server side for data processing. For this reason, the problem with this identification device is that the system device configuration becomes complex and a simply-structured, low-cost system cannot be built.

For an identification device on which a storage medium such as a magnetic card or an IC card is used, identification data for identifying a user is recorded in a magnetic material or an IC chip on a plastic card. The user carries this card at all times and, where personal identification is required, places this card over a detection device. The problem with this identification device is that the user must carry the card at all times and, if the user fails to carry the card, the user cannot be personally identified. Another problem is that, when a card is stolen, there is a possibility that a third party other than a cardholder impersonates the cardholder for personal identification.

Personal identification that is made by a combination of biometrics and card-based identification is also proposed (For example, see Patent Document 1). FIG. 22 is a general diagram showing a personal identification device that is made by a combination of biometric identification and card-based identification. This personal identification device 101 comprises a fingerprint sensor 110a for detecting the fingerprint of a finger 100 of a user and card reading means 101b for reading storage medium 102a provided on a card 102. The personal identification device 101 compares the fingerprint data on a fingerprint 100a detected by the fingerprint sensor 101a with fingerprint data acquired from the storage medium 102a via the card reading means 101b for personal identification.

Patent Document 1: Japanese Patent Laid-Open Publication No. 2002-83289

### DISCLOSURE OF THE INVENTION

The personal identification device that is made by a combination of biometric identification and card-based identification described above eliminates the need for a server that manages personal identification data and solves the problem of impersonation when a card is stolen. However, a user must still carry a card at all times, and the problem that a user who fails to carry a card cannot be identified still remains unsolved.

In addition, to identify the identity, a user must position the finger 100 of the fingerprint 100a, which is the same as that registered in the card 102 carried by the person, on the fingerprint sensor 101a to cause it to read the fingerprint data and, at the same time, position the card 102 on the card reading means 101b to cause it to read the fingerprint identification data.

This means that a user must cause the device to read the fingerprint data and to acquire the fingerprint identification data from the card via two separate operations for comparing fingerprints. Therefore, the personal identification device is not easy to operate.

In view of the foregoing, it is an object of the present invention to solve the problems of the prior art described above. More specifically, an object of the present invention is to provide a device that reads fingerprint data and acquires fingerprint identification data from a storage medium via a single operation.

The present invention relates to a personal identification device and to a system that has this personal identification device and performs operation based on the identification of identity.

A first embodiment of the present invention is a personal identification device comprising a fingerprint sensor that detects a fingerprint; and a scanner that calls a storage medium mounted on a portable device worn on a finger, a wrist, or an ankle of a user for reading recording information stored on the storage medium; the fingerprint sensor and the scanner being integrally provided in a device main body of the personal identification device. The personal identification device further comprises fingerprint comparison means for comparing fingerprint data of a user's finger detected by the fingerprint sensor with fingerprint comparison data read by the scanner from the storage medium of the portable device worn on the finger, the wrist, or the ankle of the user. The fingerprint comparison means identifies that the holder of the storage medium is an authentic user based on a match between the fingerprint data and the fingerprint comparison data.

The personal identification device according to the present invention has a configuration in which the fingerprint sensor and the scanner are integrally provided in the device main body. This configuration allows the user to obtain user's fingerprint data via the fingerprint sensor and to read the fingerprint comparison data, which is stored in the storage medium of the portable device worn on a user's finger, a wrist, or an ankle, via the scanner at the same time simply by performing one operation on the device main body.

The portable device, with a shape of a ring or a bracelet, can be carried at all times by wearing it on a user's finger, wrist, or ankle. In addition, at the same time the fingerprint is detected, the fingerprint comparison data, which is stored in the storage medium on the portable device, can be read.

The fingerprint sensor and the scanner are positioned on the device main body where the detection of a user's fingerprint by the fingerprint sensor and the reading of the storage medium mounted on the portable device worn by the user can be performed at the same time. For example, when a ring-shaped portable device is used, the fingerprint sensor detects the fingerprint of a user's finger and the scanner reads the storage medium mounted on the ring-shaped portable device worn on that finger. The ring-shaped portable device need not be worn on the finger whose fingerprint is detected but may be worn on any finger within the detection range of the scanner.

The portable device of the present invention may be worn on a finger of a hand or on a finger of a foot. For example, when the portable device is worn on a finger of a hand, the fingerprint comparison data on the finger of the hand, on which the storage medium is worn, is recorded and the fingerprint data on the finger of the hand obtained by the fingerprint sensor is compared with the fingerprint comparison data for identification. Similarly, when the portable device is worn on a finger of a foot, the fingerprint comparison data on the finger of the foot on which the storage medium is worn is recorded and the fingerprint data on the finger of the foot obtained by the fingerprint sensor is compared with the fingerprint comparison data for identification.

Especially, a ring-shaped portable device worn on a finger of a foot does not come off the finger less easily than that worn on a finger of a hand because the tip of a finger of a foot is usually thicker than the bottom.

When a bracelet-shaped portable device is used, the fingerprint sensor detects the fingerprint of a user's finger and the scanner reads the storage medium provided on the bracelet-shaped portable device worn on the wrist of the hand or the ankle of the foot whose fingerprint is detected.

The fingerprint sensor can detect the fingerprint, and the scanner can read the storage medium, through the operation for the same finger or the same hand. Therefore, the two operations, that is, fingerprint detection and card reading, that are required for card-based identification are not necessary but only one operation is necessary.

The device main body may further comprise display means. When the user is confirmed as authentic as a result of fingerprint comparison, the scanner reads recording information stored in the storage medium for display on the display means.

The personal identification device according to the present invention can also cause the scanner to read identifying data, which identifies an individual, from the recording information stored in the storage medium based on the fingerprint comparison and send the identifying data to an external server to obtain personal information, which is identified by the identifying data, from the external server.

The personal identification device according to the present invention can also send the fingerprint data, detected by the fingerprint sensor, to an external server based on the fingerprint comparison to obtain personal information, which is identified by the fingerprint data, from the external server.

A second embodiment of the present invention is a system having a personal identification device.

A first mode of the second embodiment, applicable to the sealing and sign processing, comprises the personal identification device and an electronic sealing device that outputs seal data. The personal identification device uses the scanner to read seal data from the recording information stored in the storage medium based on the fingerprint comparison and sends the seal data to the electronic sealing device. The electronic sealing device can write the seal data, which is read and sent by the scanner, to an external device and read the seal data, which has been written, from the external device.

The device main body may further comprise display means to display the seal data, which is read from the storage medium and/or the seal data read from the external device, for confirmation.

The electronic sealing in the first mode eliminates the need for storing seal data in the server and eliminates the need for accessing the server during operation, thus allowing the user to perform the sealing processing in a simple configuration and via a simple operation.

A second mode, applicable to the locking/unlocking of a lock, comprises the personal identification device and a lock device that is unlocked by the comparison of identification data. The personal identification device uses the scanner to read identification data from the recording information stored in the storage medium based on the fingerprint comparison and sends the identification data to the lock device. The lock device is unlocked by a comparison between the identification data, which is read and sent by the scanner, with the identification data stored in advance.

The lock device in the second mode eliminates the need for a key and a card for unlocking, obtains identification data from the storage medium at the same time fingerprint data is obtained, unlocks the lock using this identification data, and eliminates the need for accessing the server when the lock is unlocked, thus allowing the user to unlock the lock in a simple configuration and via a simple operation.

The system in the second embodiment, which has the personal identification device in the first embodiment, allows the user to perform processing, based on the personal identification, in a simple configuration.

As described above, the present invention allows the user to read fingerprint data and to obtain identification fingerprint data from a storage medium via one operation.

### BRIEF DESCRIPTION OF THE DRAWINGS

FIG. 1 is a general diagram showing the configuration of a personal identification device of the present invention.

FIG. 2 is a general diagram showing the positional relation between a fingerprint sensor and a scanner of the personal identification device of the present invention and how a user performs operation.

FIG. 3 is a general diagram showing the personal identification executed by the personal identification device of the present invention and an example of processing operation based on the personal identification.

FIG. 4 is a diagram showing the signal relation among the personal identification device of the present invention, a user, and an external device.

FIG. 5 is a diagram showing an example of the application of the personal identification device of the present invention to a lock device.

FIG. 6 is a diagram showing the signal relation among the personal identification device of the present invention, a user, and an electronic sealing device.

FIG. 7 is a diagram showing an example of the application of the personal identification device of the present invention to an electronic sealing device.

FIG. 8 is a diagram showing information inquiry processing via the personal identification of the present invention.

FIG. 9 is a diagram showing the relation between the fingerprint sensor and the scanner of the personal identification device of the present invention.

FIG. 10 is a diagram showing the configuration of a ring-shaped or bracelet-shaped portable device used in the personal identification device of the present invention.

FIG. 11 is a diagram showing an example of the configuration of a storage medium provided on the portable device of the present invention.

FIG. 12 is a diagram showing an example of the configuration in which an antenna is provided in a strip member of the storage medium of the present invention.

FIG. 13 is a diagram showing an example of the configuration in which an antenna is provided in a strip member of the storage medium of the present invention.

FIG. 14 is a diagram showing an example of the application of the personal identification device of the present invention in various stages in the medical field.

FIG. 15 is a diagram showing the use of the personal identification device of the present invention in the examination stage.

FIG. 16 is a diagram showing the use of the personal identification device of the present invention in the examination stage.

FIG. 17 is a diagram showing the use of the personal identification device of the present invention in the medication/treatment stage.

FIG. 18 is a diagram showing the use of the personal identification device of the present invention in the medicine preparation stage.

FIG. 19 is a diagram showing the use of the personal identification device of the present invention in the medicine counter handover stage.

FIG. 20 is a diagram showing the use of the personal identification device of the present invention in the medicine reception stage.

FIG. 21 is a diagram showing the identification of identity using medical care history of the personal identification device of the present invention.

FIG. 22 is a general diagram showing a personal identification device that combines biometric identification with card-based identification.

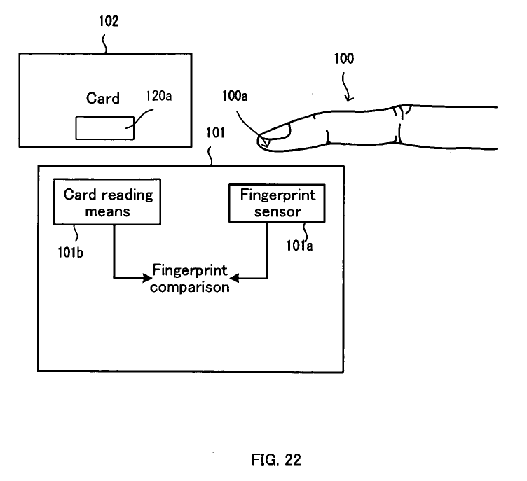

### DESCRIPTION OF SYMBOLS

1 Personal identification device
1a Fingerprint sensor
1b Scanner
1c Fingerprint comparison means
1d Recording means
1e Output means
1f Display means
1g Code management means
1h Output means
1i Input/output means
1j Input means
1k Comparison means
1f Display means
2 Storage medium
2a Medium chip
2b Circuit pattern
2c Circuit substrate
2d Capacitor
2e Antenna
3 Portable device
3a Strip member
3b Indented part
3c Circle member
3d Openings
3e Antenna
10 External device
11 Electric seal device
12 Lock device
20 Server
20a Temporary code issuance management device
20b Code issuance management device
20c Temporary code management device
20d History management device
30 Information processing device
40 Door
50 Sheet
51 Storage medium
60 Cylindrical member
70 Door
71 Doorknob
100 Finger
100a Fingerprint
101 Personal comparison device
101a Fingerprint sensor
101b Card reading device
102 Card
102a Storage medium
110 Examination stage
120 Medication/treatment stage
121 Medicine
130 Medicine preparation stage
131 Medicine
140 Medicine counter-handover stage
150 Medicine reception stage

### BEST MODE FOR CARRYING OUT THE INVENTION

An embodiment of the present invention will be described in detail with reference to the drawings.

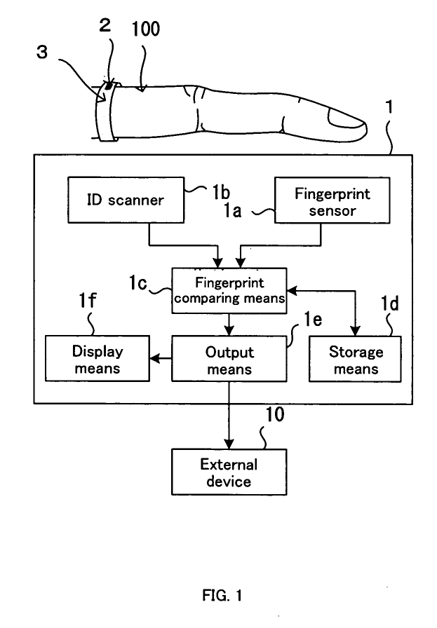

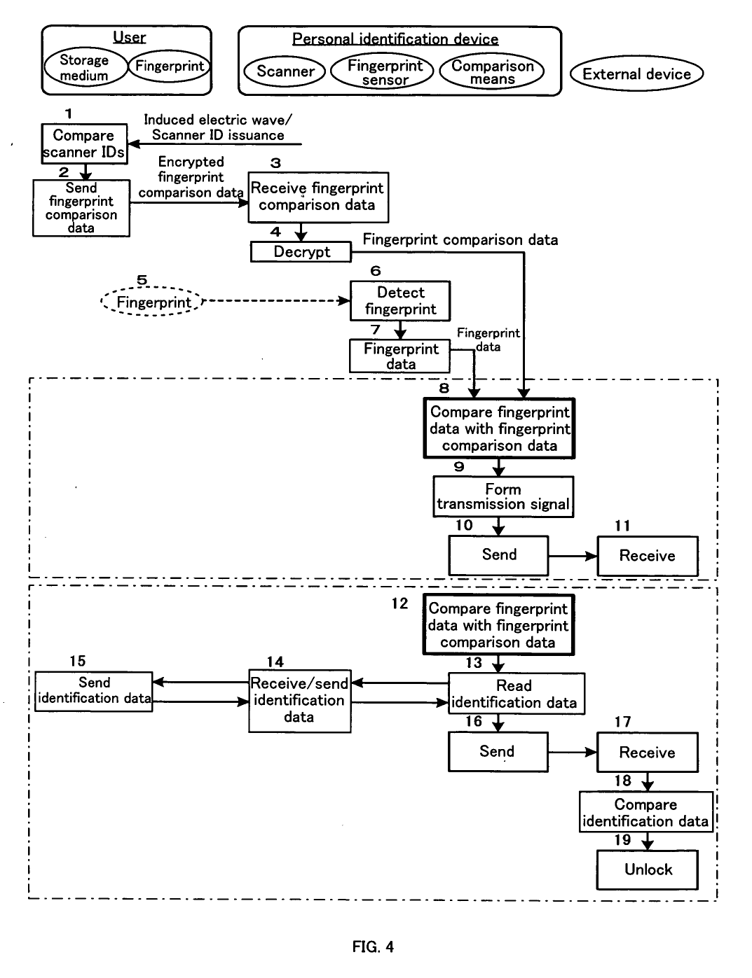

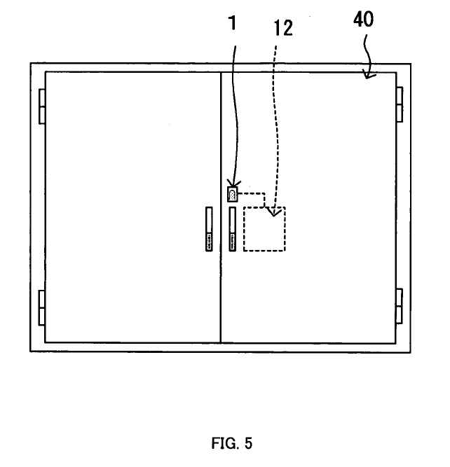

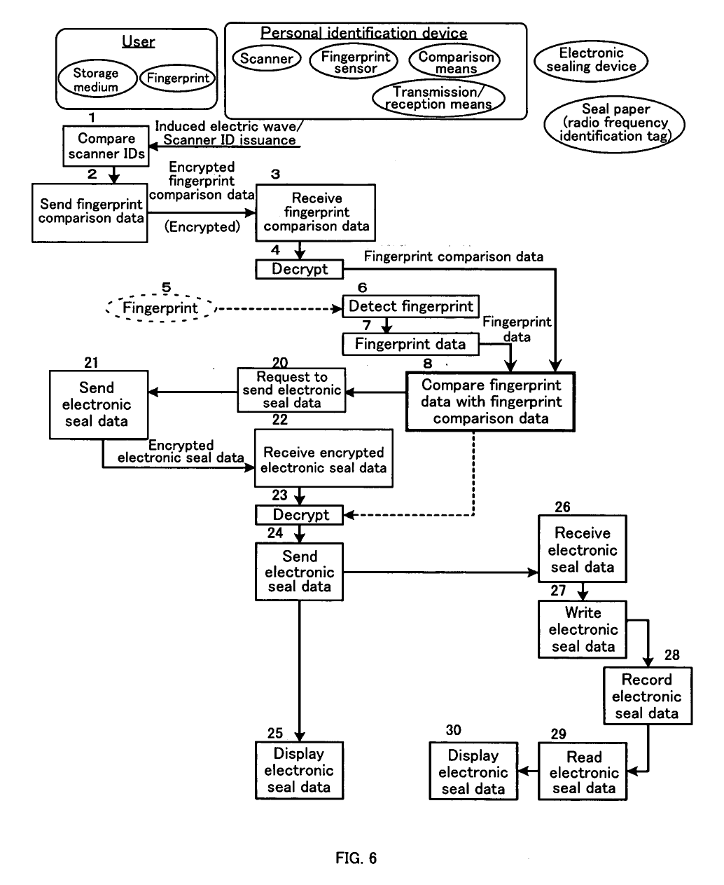

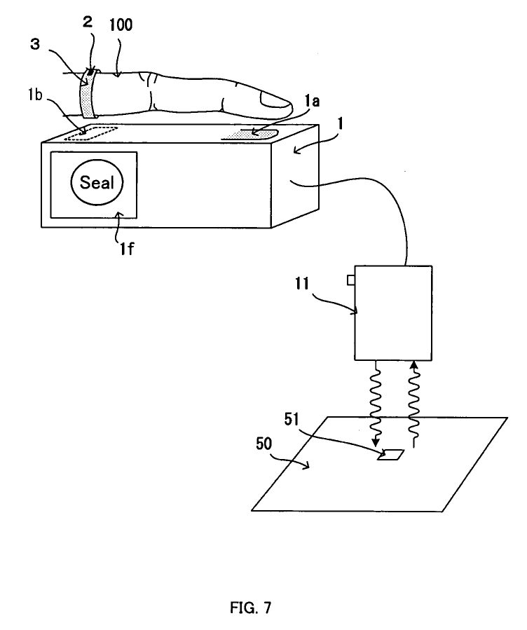

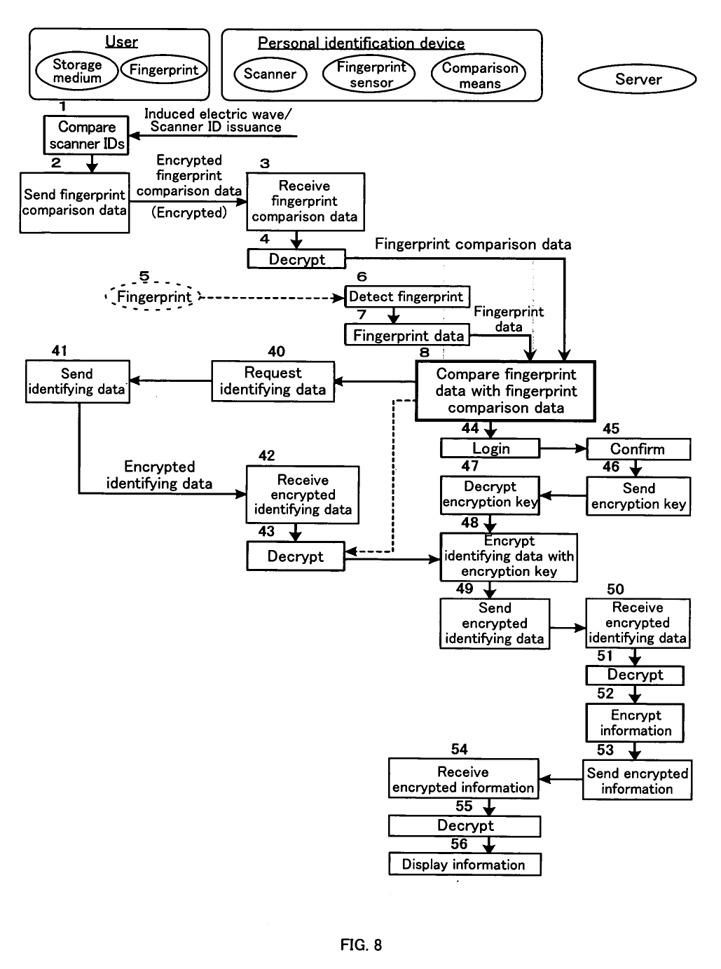

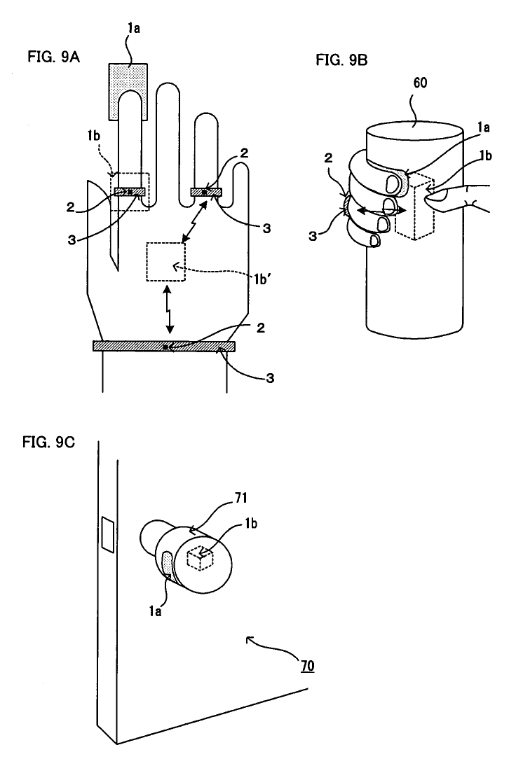

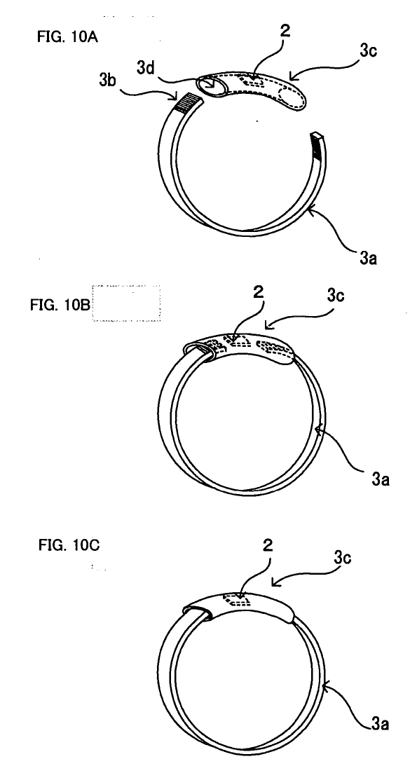

The configuration and processing of a personal identification device of the present invention will be described with reference to FIGS. 1-4, unlocking processing via personal identification of the present invention will be described with reference to FIGS. 4-5, electronic seal processing via personal identification of the present invention will be described with reference to FIGS. 6-7, and information inquiry processing via personal identification of the present invention will be described with reference to FIG. 8. The relation between a fingerprint sensor and a scanner in the personal identification device of the present invention will be described with reference to FIG. 9, and the configuration of a ring-shaped or bracelet-shaped portable device used on the personal identification device of the present invention will be described with reference to FIG. 10.

FIG. 1 is a general diagram showing the configuration of a personal identification device. Referring to FIG. 1, a personal identification device 1 comprises a fingerprint sensor 1a and a scanner 1b. The fingerprint sensor 1a detects the fingerprint of a finger 100 of a user. The scanner 1b calls a storage medium 2 mounted on a portable device 3 attached to the finger 100, the wrist, or the ankle of a user and reads recording information stored in the storage medium 2. The fingerprint sensor 1a and the scanner 1b are provided integrally in the device main body of the personal identification device 1.

The personal identification device 1 comprises fingerprint comparing means 1c for identifying the identity between the holder of the storage medium 3 and the authentic user through fingerprint comparison. The fingerprint comparing means 1c compares the fingerprint data of the finger of the user, which is detected by the fingerprint sensor 1a, with the fingerprint comparison data read by the scanner 1b from the storage medium 2 on the portable device 3. The fingerprint comparison means 1c compares fingerprints, for example, by extracting the characteristics of the fingerprint from the detected fingerprint data and determining if the extracted characteristics match the characteristics of the fingerprint comparison data.

In the configuration example shown in FIG. 1, fingerprint data detected by the fingerprint sensor 1a is input directly into the fingerprint comparison means 1c. Instead of this configuration, if the fingerprint sensor 1a takes long to scan the fingerprint for detecting fingerprint data, it is also possible to configure the device in such a way that fingerprint data detected by the fingerprint sensor 1a is serially stored in storage means 1d and, after all fingerprint data is detected, the stored fingerprint data is sent to the fingerprint comparison means 1c for fingerprint comparison.

The comparison result of the fingerprint comparison means 1c can be not only output to an external device 10 via output means 1e but also displayed on display means 1f provided on the device main body.

On the other hand, the storage medium 2 is an element, called a radio frequency identification tag or an IC chip that has both the recording function and the communication function, has the memory function, the communication function to or from an external device, and the driving function for generating a driving current by an induced radio wave obtained from an external source. The memory function stores, in advance, fingerprint comparison data as well as various types of data including personal information such as identifying data for identifying a user, biological data for a user, and seal data for electronic sealing, and identification data for unlocking a locking device.

The personal identification device 1 has a function for acquiring recording information recorded on the storage medium 2. For example, this function sends an induced radio wave to the storage medium 2 to drive the storage medium 2 and sends a scanner ID to the storage medium 2. The storage medium 2, driven by the current induced by the induced radio wave, compares the received scanner ID with the registered scanner ID and, if they match, sends the fingerprint comparison data to the personal identification device 1. Note that scanner comparison using scanner IDs may also be omitted.

The scanner 1b of the personal identification device 1 receives not only the fingerprint comparison data from the storage medium 2 but also various types of data such as identifying data, personal information, and identification data. The data read by the scanner 1b can be stored in the storage means 1d. Note that the personal information and the identification data can also be read from the storage medium 2 after the fingerprints are compared using the fingerprint comparison data and a fingerprint data match is confirmed.

The fingerprint sensor 1a and the scanner 1b of the personal identification device 1 of the present invention are provided integrally in the device main body. Thus, a user can cause the fingerprint sensor 1a to detect the fingerprint and, at the same time, cause the scanner 1b to read fingerprint comparison data from the storage medium 2 by simply performing a single identification operation for the device main body. Therefore, this configuration allows a fingerprint to be detected and fingerprint comparison data to be read, not separately, but in one operation.

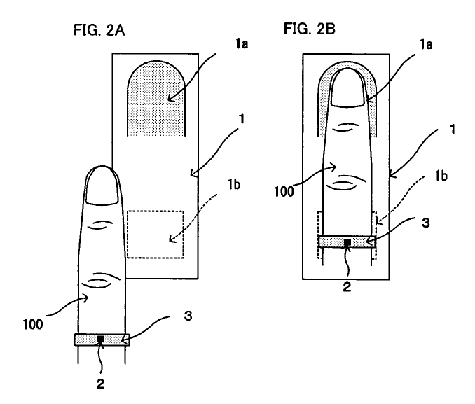

FIG. 2 is a general diagram showing the positional relation between the fingerprint sensor and the scanner and how a user performs the operation. In this figure, it is assumed that the user has the portable device 3, on which the storage medium 2 is mounted, on his or her finger 100. The user can have the ring-shaped portable device 3 always on his or her finger 100.

The fingerprint sensor 1a is provided on the outside wall of the device main body of the personal identification device 1 with its sensor surface exposed. A user contacts the fingerprint on the sensor surface to allow the sensor to detect the fingerprint. A fingerprint sensor in any detection mode can be applied.

On the other hand, the scanner 1b is provided near the fingerprint sensor 1a of the device main body. The scanner 1b is provided in a position where it can communicate with the storage medium 2 of the portable device 3 on the finger 100 when the user contacts his or her fingerprint on the fingerprint sensor 1a for fingerprint detection. The scanner 1b, if provided in such a position, can be in the range where it can communicate with the storage medium 2 when the user contacts his or her fingerprint on the fingerprint sensor 1a for fingerprint detection (FIG. 2B). Therefore, while the user keeps his or her finger in the fingerprint detection position, recorded information such as fingerprint identification data can be read from the storage medium.

When the range of the reading distance of the scanner 1b is set wide, the scanner 1b need not always be installed in a position where the portable device 3 is placed as in the configuration shown in FIG. 2. Instead, as long as the scanner 1b and the portable device 3 can communicate each other, a configuration is also possible in which there is a distance between them. This configuration allows a user to put the portable device 3 on a finger other than a finger whose fingerprint is detected.

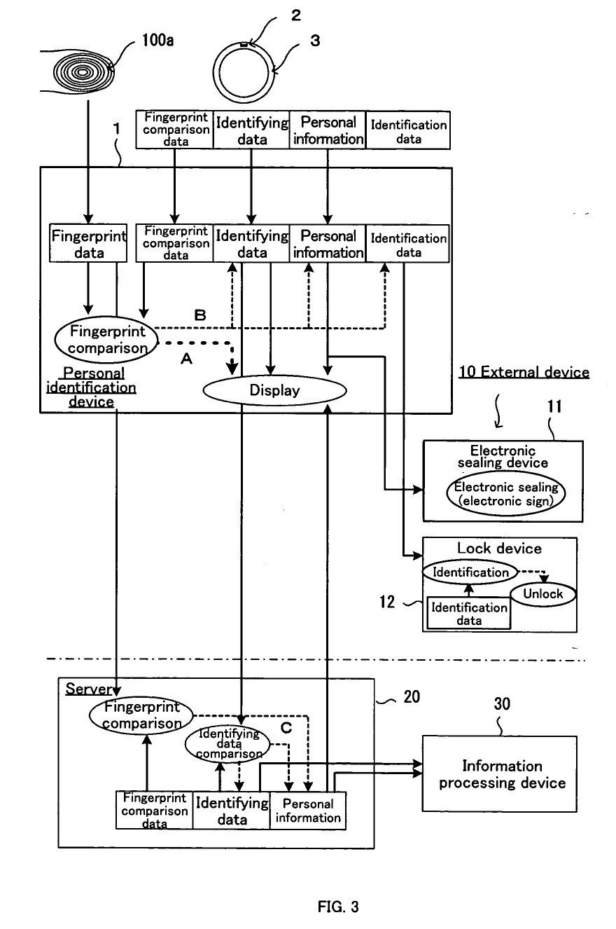

FIG. 3 is a general diagram showing the personal identification by the personal identification device of the present invention and an example of processing operation based on the personal identification.

The storage medium 2 mounted on the portable device 3 stores, in advance, fingerprint comparison data, identifying data for identifying an individual, personal information unique to an individual, and identification data used for identification with a one-to-one correspondence with the external device 10. To identify a person, the device compares fingerprint data, acquired by the fingerprint sensor 1a that detects the fingerprint 100a of a user, with the fingerprint comparison data acquired by the scanner 1b from the storage medium 2.

The fingerprint comparison result can be not only displayed on display means (broken line A in the figure) but also sent to the external device 10 or a server 20 that uses the result. The external device 10 is, for example, an electronic sealing device 11 or a lock device 12.

The electronic sealing device 11, which electronically performs the seal or sign operation, sends pre-recorded seal data to recording means mounted on a document instead of actually performing the seal or sign operation. The lock device 12 electrically locks and unlocks a safe, a locker, or a door. The lock device 12 unlocks the safe, the locker, or the door by identifying pre-registered identification data.

Seal data can be stored, for example, in the personal information in the storage medium 2 and identification data can be stored, for example, in the storage medium 2. The seal data and the identification data can be read at the same time the fingerprint comparison data is read or after the fingerprint comparison is finished.

When reading after the fingerprint comparison is finished, the seal data or the identification data stored in the storage medium 2 is read based on the fingerprint comparison as shown by the broken line B in FIG. 3 and the data that is read is sent to the external device 10 such as the electronic sealing device 11 or the lock device 12. The seal data or the identification data, if read based on the fingerprint comparison, can increase the safety of the sealing or unlocking processing.

The personal identification device 1, if connected to the server 20, can identify the identity of a user more correctly or send information on a user of some other information processing device. The server 20 stores user-identifying data, more detailed user fingerprint comparison data, and personal information stored in a database and compares the fingerprint data, which is received from the personal identification device 1, with more detailed fingerprint comparison data to increase the accuracy of identifying the identity. The server 20 compares the fingerprints as well as the identifying data for identifying user's identity.

After identifying user's identity (broken line C in the figure), the server 20 can send the identifying data and the personal information to another information processing device 30. The information processing device 30, installed in an medical institution or a public institution, can receive biological data managed by the server 20 or personal information such as addresses, names, and birth dates.

FIG. 4 is a diagram showing the signal relation among the personal identification device, a user, and an external device. In conjunction with a configuration example in FIG. 5, the following describes an example of transmission to a lock device that is an external device. Note that the numerals appearing in the description below correspond to the numerals in the figure.

First, the scanner 1b of the personal identification device 1 sends an induced radio wave to the storage medium 2 mounted on the portable device 3 worn by the user and, at the same time, issues a scanner ID identifying the sending scanner (1). The storage medium 2, mounted on the portable device 3 worn by the user, receives a driving current via the induced radio wave and is driven. The storage medium 2, which is driven, compares the received scanner ID with the scanner ID stored in advance. If the received scanner ID matches the registered scanner ID, the storage medium 2 sends the user's fingerprint data, registered in advance, to the personal identification device 1 as fingerprint comparison data. This fingerprint comparison data may be encrypted before being transmitted.

If the scanner ID of the sending scanner is not registered, the storage medium 2 does not respond or returns information indicating that the scanner ID is an unregistered scanner ID. It is also possible to omit the scanner ID comparison processing and, in response to a fingerprint comparison data request, to send encrypted fingerprint comparison data (2).

The scanner 1b of the personal identification device 1 receives the encrypted fingerprint comparison data (3), decrypts it, and acquires the fingerprint comparison data (4). On the otherhand, the fingerprint sensor 1a of the personal identification device 1 detects the fingerprint of the user (5, 6) to acquire fingerprint data (7).

The fingerprint comparing means 1c compares the acquired fingerprint comparison data with the fingerprint data. To compare the fingerprint data, the fingerprint comparing means 1c extracts pre-set characteristics points from the fingerprint data and determines if the characteristic points match the characteristics points in the fingerprint comparison data. The personal identification device 1 of the present invention acquires the fingerprint comparison data, which is used for this fingerprint comparison, from the storage medium mounted on the portable device worn by the user. This eliminates the need for managing fingerprint comparison data (for example, the need for registering fingerprint comparison data in advance or inquiring the server about fingerprint comparison data), thus making the system simple (8).

When the user's identity is identified by comparing the fingerprints, the personal identification device 1 forms a confirmation signal confirming the user's identity (9) and sends the confirmation signal to the external device (10). The external device receives this confirmation signal, which confirms user's identity, and performs predetermined processing (11).

The processing enclosed by the chain line shown in the bottom of FIG. 4 indicates an example in which the external device is a lock device.

The fingerprint comparing means 1c compares the acquired fingerprint comparison data with the fingerprint data (12) and, if user's identity is identified, reads identification data for unlocking the lock device 12. This identification data, which is used as a key to unlock the lock device 12, is allocated to a user registered with each lock device 12 and is stored in the storage medium 2 in advance.

The personal identification device 1 acquires identification data from the storage medium 2 via communication between the scanner 1b and the storage medium 2 (13-15) and sends the acquired identification data to the lock device 12 that is an external device (16). The lock device 12 receives the identification data (17) and compares this identification data with the registered identification data (18). If both identification data match, the lock device 12 is unlocked (19). It is also possible to encrypt the identification data and to cause the external device to decrypt it before comparison in order to increase the security of the external device.

FIG. 5 is a diagram showing an example of the application of the personal identification device of the present invention to a lock device in which the personal identification device is used in the door of a safe or in the door of a locker. In the example shown in FIG. 5, the personal identification device 1 of the present invention is installed in a door 40 and identification data acquired by the personal identification device 1 is sent to the lock device 12. The personal identification device 1 may be installed in any position of the door 40. For example, when the lock device 12 is provided near the handle of the door 40, the acquisition of fingerprint data by the fingerprint sensor, the acquisition of the fingerprint comparison data and identification data by the scanner, and the opening operation of the door 40 are executed as a sequence of operations.

In a configuration in which a card is used for identifying the user's identity and, based on the identification of the identity, the door is unlocked and opened, at least two operations are necessary, that is, the card is read by the card reader and the door is opened. In contrast, a system to which the personal identification device of the present invention is applied eliminates the need for reading a card. Therefore, the user's identity is identified and, at the same time, the door is opened.

Next, an example in which the external device is an electronic sealing device will be described with reference to FIGS. 6 and 7. FIG. 6 is a diagram showing the signal relation among the personal identification device, a user, and an electronic sealing device, and FIG. 7 is a diagram showing an example of the application to an electronic sealing device.

Note that the numerals appearing in the description below correspond to the numerals in the figure.

First, the fingerprint data is compared with the fingerprint comparison data as in steps (1) to (8) in FIG. 4 described above.

The fingerprint comparing means 1c compares the acquired fingerprint comparison data with the fingerprint data (8) and, if the user's identity is identified, reads electronic seal data to be used by the electronic sealing device 11. This electronic seal data is data used by the electronic sealing device 11 for electronic sealing. For example, the electronic seal data is sent to an organization where sealing is required or is sent to a storage medium included in a stamp or a document for recording therein to perform processing equivalent to sealing. This electronic seal data, specific to each user, is stored in the storage medium 2 in advance. The electronic seal data stored in the storage medium 2 is read by the personal identification device 1 of the present invention as necessary and is written by the electronic sealing device 11 to perform processing alternative to sealing or signing.

After fingerprint comparison, the personal identification device 1 acquires encrypted electronic seal data stored in the storage medium 2 via communication between the scanner 1b and the storage medium 2 (20-22). The personal identification device 1 decrypts the acquired electronic seal data (23) and sends the decrypted electronic seal data to the electronic sealing device 11 (24). At this time, the electronic seal data may also be displayed on the display means if. This electronic seal data may also be displayed as a seal image (25).

In steps (20-22) described above, the electronic seal data is acquired based on the fingerprint comparison. Instead, it is also possible to acquire the electronic seal data from the storage medium regardless of the result of the fingerprint comparison and, only if the fingerprint is successfully confirmed, to decrypt the encrypted electronic seal data.

The electronic sealing device 11 receives the electronic seal data sent from the personal identification device 1 (26) and writes this electronic seal data in a storage medium, for example, a radio frequency identification tag, included in a document such as a stamp or a seal sheet for recording therein (27, 28). The electronic sealing device 11 reads the electronic seal data that was written (29) and displays it on the display means 1f (30).

The display means if displays, side by side, the electronic seal data read from the storage medium 2 and the electronic seal data read by the electronic sealing device 11 to allow the user to confirm the seal.

FIG. 7 is a diagram showing an example in which the personal identification device of the present invention is applied to an electronic sealing device. In the example shown in FIG. 7, the personal identification device 1 is connected to the electronic sealing device 11.

As described above, the personal identification device 1 detects the fingerprint data of a user via the fingerprint sensor 1a, reads the fingerprint comparison data from the storage medium 2 mounted in the portable device 3 via the scanner 1b for identifying the user's identity and, based on the identification of user's identity, acquires the electronic seal data from the storage medium 2.

The personal identification device 1 sends the acquired electronic seal data to the electronic sealing device 11. The electronic sealing device 11 writes the electronic seal data in a storage medium 51, such as a radio frequency identification tag, pasted on a sheet 50 such as a stamp or a seal sheet, reads the written electronic seal data, and returns it to the personal identification device 1 for displaying it on the display means 1f.

The personal identification device 1 can acquire fingerprint data via the fingerprint sensor and also acquire fingerprint comparison data and electronic seal data via the scanner in one operation. Although the sealing operation by the electronic sealing device 11 can be performed by the switch provided on the electronic sealing device main body, it is also possible to treat the sealing operation only as a sealing time confirmation and to perform the sealing operation when the personal identification device 1 identifies the user's identity.

In a configuration in which a card is used for identifying the identity of a user and, based on the identification of the identity, electronic sealing processing is performed, at least two operations are necessary, that is, the card is read by the card reader and the electronic sealing processing is performed. In contrast, a system to which the personal identification device of the present invention is applied eliminates the need for reading a card. Therefore, the user's identity is identified and, at the same time, the electronic sealing processing is performed.

Next, with reference to FIG. 8, the following describes an example in which information is acquired from a server based on the user's identity identified by the personal identification device of the present invention. FIG. 8 is a diagram showing the signal relation among the personal identification device, a user, and a server. Note that the numerals appearing in the description below correspond to the numerals in the figure.

First, the fingerprint data is compared with the fingerprint comparison data as in steps (1) to (8) in FIG. 4 described above.

The fingerprint comparing means 1c compares the acquired fingerprint comparison data with the fingerprint data (8) and, if the user's identity is identified, reads identifying data for identifying user's identity to acquire information from the server. This identifying data, which is data for identifying the user's identity in the server 20, is registered and recorded in the server 20 and in the storage medium 2 mounted in the portable device 3 carried by the user.

The personal identification device 1 of the present invention reads the identifying data from the storage medium 2 as necessary, uses this identifying data to identify the user's identity, and acquires information.

After the fingerprint comparison, the personal identification device 1 acquires encrypted identifying data stored in the storage medium 2 via communication between the scanner 1b and the storage medium 2 (40-42). The personal identification device 1 decrypts the acquired identifying data (43). In steps (40-42) described above, the identifying data is acquired based on the fingerprint comparison. Instead, it is also possible to acquire the identifying data from the storage medium regardless of the result of the fingerprint comparison and, only if the fingerprint is successfully confirmed, to decrypt the encrypted identifying data.

After the fingerprint comparison, the personal identification device 1 logs into the server 20 (44). The server 20 confirms the login from the personal identification device 1 (45) and sends the encryption key (46). The personal identification device 1 decrypts the encryption key sent from the server 20 (47), uses this encryption key to encrypt the acquired identifying data (48), and sends the encrypted identifying data to the server 20 (49).

The server 20 receives the encrypted identifying data (50) and decrypts it (51). The server 20 identifies the user based on the identifying data, reads the requested personal information from the recorded user information and encrypts it (52), and sends the encrypted information to the personal identification device 1 (53). The personal identification device 1 receives the encrypted personal information (54), decrypts it (55), and displays it on the display means 1f.

In the personal identification device 1 of the present invention, the fingerprint sensor 1a and the scanner 1b may be arranged in the device main body not only in the configuration shown in FIGS. 1 and 2 but also in another configuration. FIG. 9 is a diagram showing another arrangement configuration of the fingerprint sensor and the scanner of the personal identification device.

In FIG. 9A, the scanner 1b may be placed in any position in the device main body as long as the scanner 1b is in a range where it can communicate with the storage medium 2 mounted on the portable device 3 worn by the user when the user touches the fingertip on the fingerprint sensor 1a.

The scanner 1b shown in FIG. 9A, where the communication distance is short, acquires information only from the storage medium 2 mounted on the ring-shaped portable device 3 on the finger whose fingerprint is detected by the fingerprint sensor 1a.

The scanner 1b shown in FIG. 9A, where the communication distance is long, acquires information from the storage medium 2 mounted either on the ring-shaped portable device 3 on a finger other than the finger whose fingerprint is detected by the fingerprint sensor 1a or on the bracelet-shaped portable device 3 on a wrist or an ankle.

FIG. 9B shows an example of the configuration in which the fingerprint sensor 1a is provided on the external surface of a cylindrical member 60 with the scanner 1b within it. This configuration allows the user's identity to be identified when the user holds the cylindrical member 60. This configuration can be applied to the steering wheel of a car or the handlebar of a bicycle.

FIG. 9C is an example of the configuration in which the personal identification device is applied to a doorknob 71 of a door 70. The fingerprint sensor 1a is provided on the external surface of the doorknob 71 with the scanner 1b within it. This configuration allows the user's identity to be identified when the user grasps the doorknob 71.

Next, an example of the configuration of the portable device used in the personal identification device of the present invention will be described with reference to FIG. 10. The portable device 3, with a shape similar to a ring or a bracelet that is put on user's finger, wrist, or ankle, has the storage medium 2 built in a part of the loop.

The portable device 3 comprises a strip member 3a and a circle member 3c. This strip member 3a is bent with both ends inserted into, and fixed in, the opening ends of the circle member 3c to form a ring. FIG. 10A shows the state before the strip member 3a is inserted into the circle member 3c.

The strip member 3a and the circle member 3c are made of resin, and the circle member 3c is made of thermoplastic resin contractible with heat. The portable device 3, composed of the strip member 3a and the circle member 3c, can be sized to fit user's finger, wrist, or ankle.

To form a loop, the strip member 3a is put on user's finger, wrist, or ankle, and both ends are inserted into openings 3d of the circle member 3c for adjusting the lengths of the parts that are inserted. The loop is sized to fit user's finger, wrist, and ankle (FIG. 10B) and the circle member 3c is heated for contracting and fixing (FIG. 10C). In this way, the loop can be sized to fit user's finger, wrist, or ankle.

At this time, the indented part such as grooves, if provided on both ends of the strip member 3a, increases friction between the ends of the strip member 3a and the circle member 3c when the strip member 3a is inserted into, and fixed in, the circle member 3c. This prevents the ends of the strip member 3a from coming off the circle member 3c. Multiple strip member 3a of different lengths may also be prepared to fit various sizes of user's finger, wrist, and ankle.

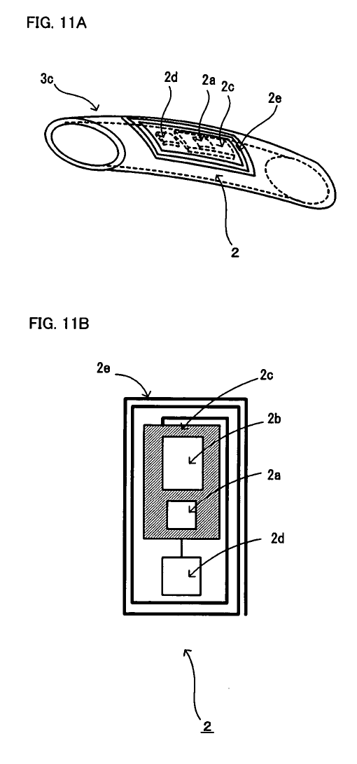

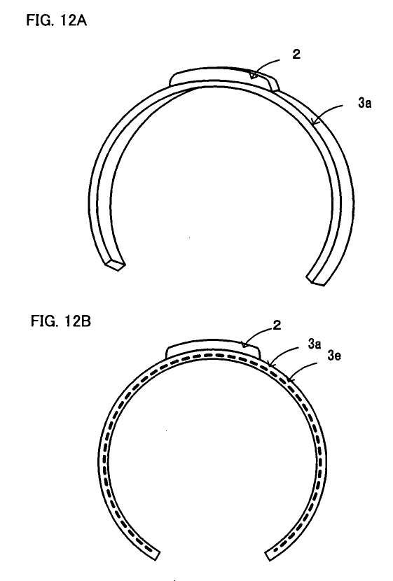

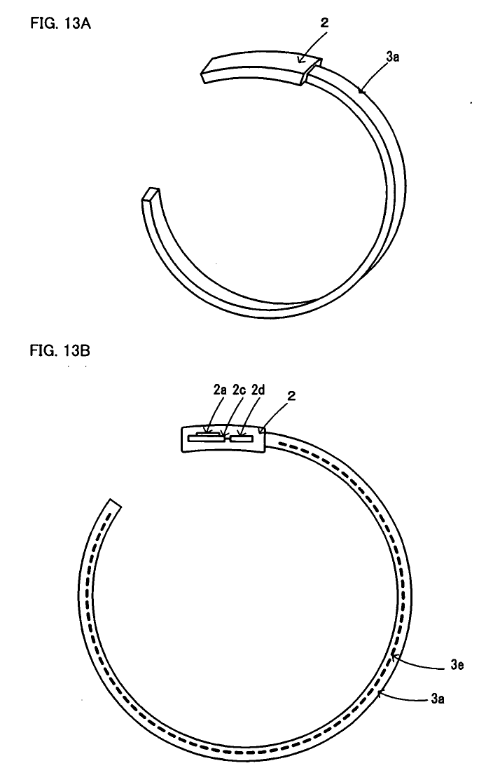

The following describes an example of the configuration of the storage medium 2 on the portable device 3 with reference to FIG. 11, and another example of the configuration of the portable device with reference to FIGS. 12 and 13.

Referring to FIG. 11, the storage medium 2 on the portable device 3 comprises a medium chip 2a sometimes called an IC chip, a circuit pattern 2b for driving this medium chip 2a, a circuit substrate 2c that constitutes the medium chip 2a and the circuit pattern 2b, a capacitor 2d that works as the driving power, and an antenna 2e that sends and receives data to and from an external device and supplies power. The capacitor 2d receives power necessary for the circuit substrate 2c side via high-frequency electromagnetic induction from an external device. FIG. 11B shows an example of element arrangement, but the actual arrangement is not limited to this example. FIG. 11A shows an example in which the storage medium 2 is provided on the circle member 3c. When forming the circle member 3c, the storage medium 2 may be integrated into the circle member 3c or may be pasted on the surface of the circle member 3c that is formed. When the storage medium 2 is pasted on the surface, the external surface of the pasted storage medium 2 may also be coated with resin to form a protective film.

The storage medium 2 may be built in a configuration other than the configuration in which the storage medium 2 is provided on the circle member 3c of the portable device 3 such as the one shown in FIG. 11A. FIGS. 12 and 13 are diagrams showing other configurations in which the storage medium is provided.

The antenna 2e provided in the storage medium 2 should preferably be long in length and large in size to increase the sensitivity of transmission and reception to and from an external device.

FIGS. 12 and 13 are diagrams showing an example of the configuration in which the antenna 3e is provided on the strip member 3a of the storage medium 2. FIG. 12A and FIG. 13A are perspective views, and FIG. 12B and FIG. 13B are cross sectional views. The strip member 3a may have the antenna 3e embedded internally or may have it pasted on the surface of the strip member 3a. When the antenna is pasted on the surface, the external surface of the pasted antenna 3e may be coated with resin to form a protective film.

The strip member 3a in the configuration example shown in FIGS. 12 and 13 can be configured as a circular form with its part cut away and be made of an elastic resin. This configuration allows it to fit the size of the finger, wrist, or ankle of any user and to fit varying size of the finger, wrist, or ankle of the same user even if the size varies according to the physical condition.

The storage medium 2 is provided almost in the center of the circular direction of the strip member 3a in the configuration example in FIG. 12, while the storage medium 2 is provided at the end of the circular direction of the strip member 3a in the configuration example in FIG. 13. The storage medium 2 maybe provided in any position in the circular direction of the strip member 3a.

Although pasted on the outside surface of the strip member 3a in the example in FIG. 12, the storage medium 2 may also be pasted on the inside surface. The storage medium 2 may also be embedded in the strip member 3a.

When the user wears the portable device 3 on the finger, wrist, or ankle in the configuration example shown in FIG. 13, the user can wear it so that the strip member 3a, which has the antenna 3e, is opposed to the scanner of the personal identification device. When the user wears the portable device in this position, the distance between the antenna 3e and the scanner is shortened and therefore the transmission/reception sensitivity is increased. In addition, because no human body's part such as a finger, wrist, or ankle comes between the antenna 3e and the scanner, the electric wave absorption effect by the human body is reduced and the transmission/reception sensitivity can be increased.

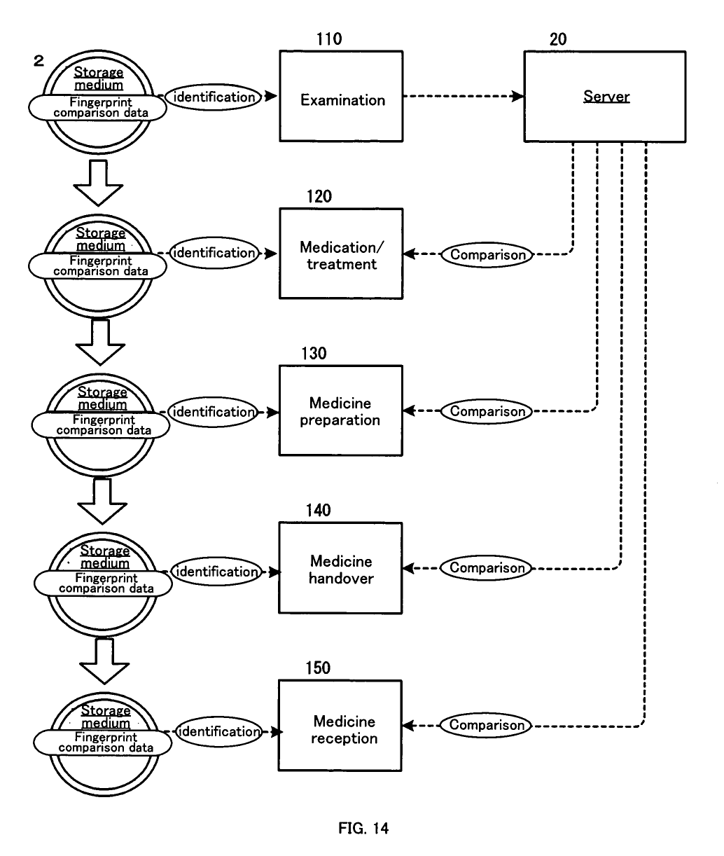

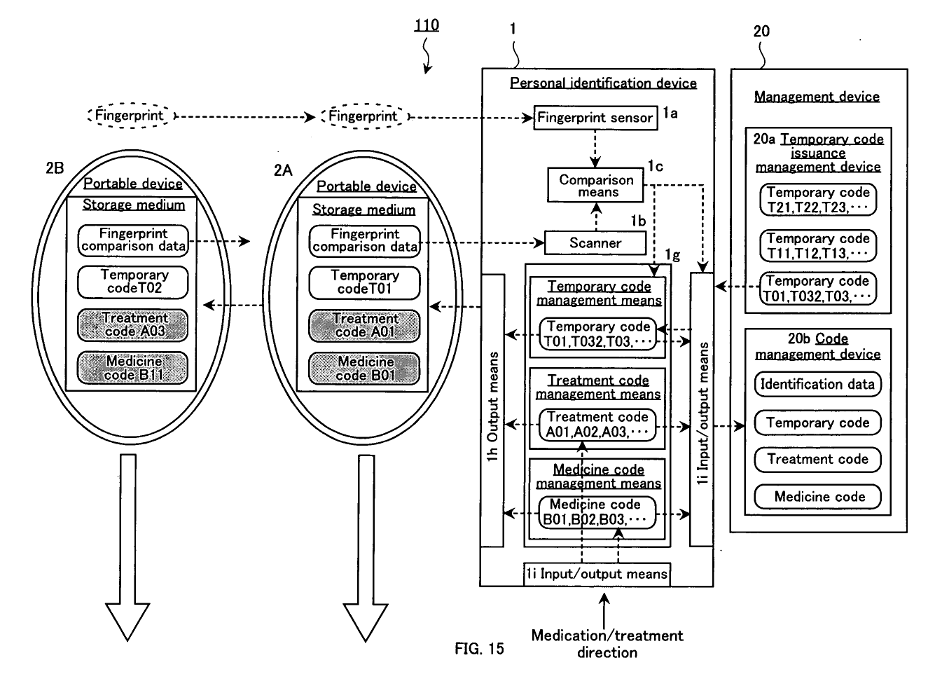

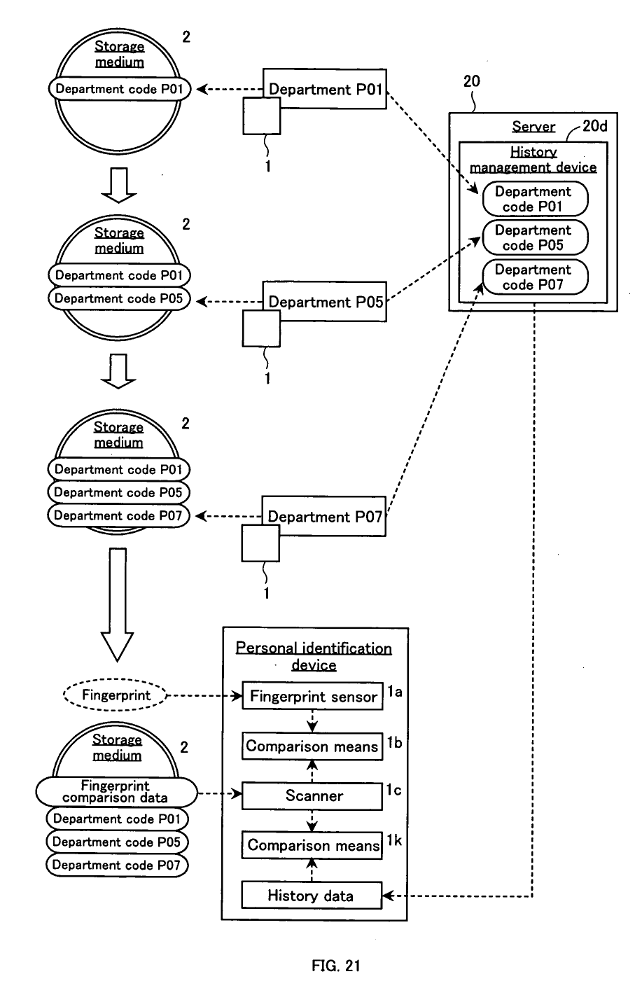

Next, an example of application of the personal identification device of the present invention to the medical field will be described with reference to FIGS. 14-21. FIGS. 15-20 show an example of application in the medication and treatment direction based on doctor's examination, the medication and treatment based on doctor's direction, the medicine preparation based on doctor's medicine direction, and the handover and reception of medicine based on doctor's medicine direction. FIG. 21 shows an example of application in which user's history data is used for identifying the identity of a user in the medical field.

FIG. 14 shows an example of application in each stage of the medical field. In the medical care stage, the present invention can be applied to the doctor's examination stage, the medication and treatment stage, the medicine preparation stage, and the medicine distribution stage. In the medicine distribution stage, either a medicine is handed over at a counter or a user receives a prepared medicine.

In each of the above medical care stages (examination stage 110, medication/treatment stage 120, medicine preparation stage 130, medicine counter-handover stage 140, and medicine reception stage 150), the storage medium 2 worn by a patient is confirmed by the personal identification device 1 as described above to identify the identity. In addition, the personal identification device 1 of the present invention is used to check and confirm the medication and treatment, specified by the doctor in the examination stage 110, in each stage (medication/treatment stage 120, medicine preparation stage 130), medicine distribution stage (medicine counter-handover stage 140, and medicine reception stage 150). By dosing so, the identity is confirmed and the directed medication/treatment is confirmed.

The following described each stage.

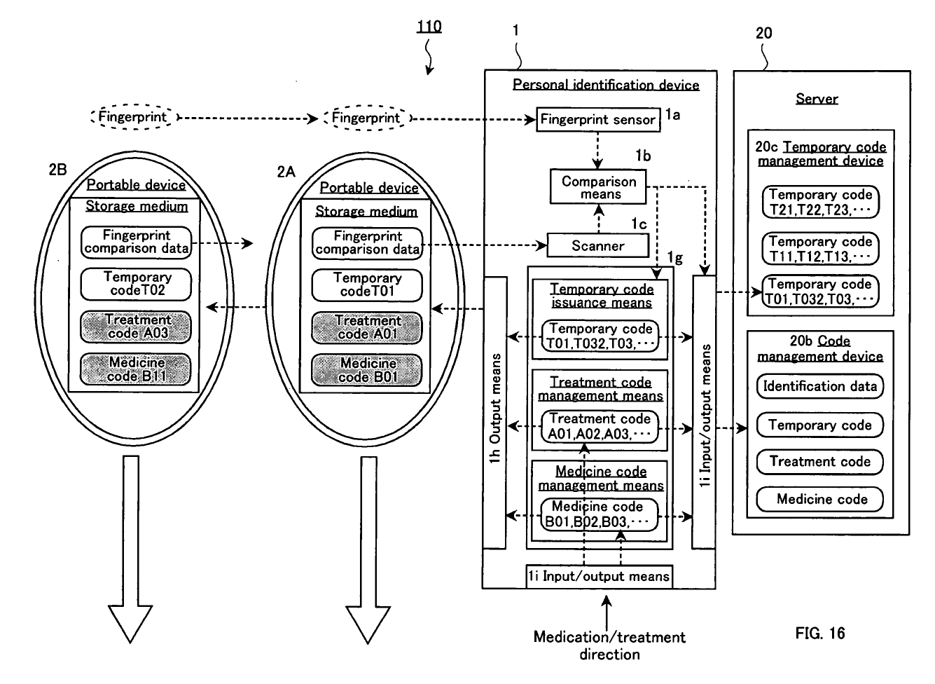

First, the following describes the examination stage 110 with reference to FIGS. 15 and 16. In the example blow, a temporary code is assigned to each medical care action, and a medication or a treatment is identified by this temporary code. This temporary code identifies a doctor, a patient, and a medication or a treatment specified by an examination.

In FIG. 15, the server 20 issues temporary codes and assigns them to the personal identification device 1 used by a doctor and so on. The temporary codes T01, T02, T03, . . . , T11, T12, T13, . . . , T21, T22, T23, . . . etc., are issued. Out of those temporary codes, T01, T02, T03, . . . are assigned to doctor X, T01, T02, T03, . . . are assigned to doctor Y, and T01, T02, T03, . . . are assigned to doctor Z.

The assigned temporary codes are stored in temporary code management means 20a in management means 1g of the personal identification device 1 owned by each doctor.

The personal identification device 1 has treatment codes (A01, A02, A03, . . . ) in treatment code management means in the management means 1g, and medicine codes (B01, T02, T03, . . . ) in medicine code management means and, when a medicine or a treatment specified by the examination is specified from input means 1j, records the corresponding codes from output means 1h to the storage medium 2(2A, 2B, . . . ) and, at the same time, records the codes from the input/output means 1i to a code management device 20b in the server 20. The medicine code and the treatment code may also be stored in the storage medium 2 with the temporary code.

When a medication or a treatment is given to different patients, different temporary codes T01 and T02 are given to the portable devices 2A and 2B of the different patients to identify the medication and treatment of the patients.

Because the temporary codes that are issued differ among doctors, each temporary code identifies not only a patient, a medication, and a treatment but also a doctor that specified them.

Although the server 20 issues a temporary code in the example shown in FIG. 15, the personal identification device 1 can also issue a temporary code. FIG. 16 shows an example in which the personal identification device 1 issues a temporary code.

Each personal identification device 1 uses the temporary code issuing means of the management means 1g to issue temporary codes each of which is unique, records the temporary codes from the output means 1h to the storage media 2 (2A, 2B, . . . ) and, at the same time, records the codes from the input/output means 1i to a temporary code management device 20c in the server 20. The other part of the configuration is the same as that shown in FIG. 15.

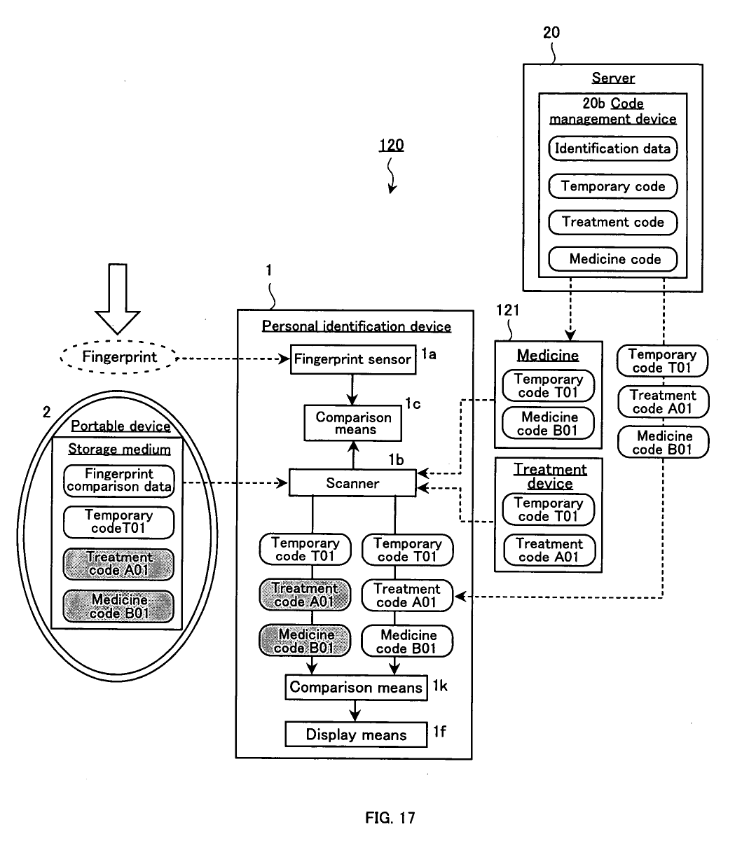

Next, the following describes the medication/treatment stage 120 with reference to FIG. 17. The storage medium 2 contains the temporary code (T01) that was set in the examination stage. In a treatment room or at a drip time, the personal identification device 1 is installed in the room or carried by the physician. This personal identification device 1 compares a fingerprint, detected by the fingerprint sensor 1a, with the fingerprint comparison data, read by a scanner 1c, via comparison means 1b as described above for personal identification. In addition, the personal identification device 1 compares the temporary code, read by the scanner 1c, with the temporary code, sent from the server 20, via comparison means 1k for confirming that the medication and the treatment are correct. The comparison result of the comparison means 1k is displayed on the display means 1f.

To confirm the medication and the treatment, the temporary code sent from the server 20 is used; in addition, the temporary code maybe recorded in a storage medium, such as a seal or an IC chip, that is attached to the medicine bag or cabinet or on the outer package of the treatment device to allow the scanner 1c to read this temporary code.

When a medicine code or a treatment code is recorded in the storage medium 2, the comparison means 1k may be used to compare not only the temporary code but also the medicine code and the treatment code. This comparison confirms the specified medicine and treatment more reliably.

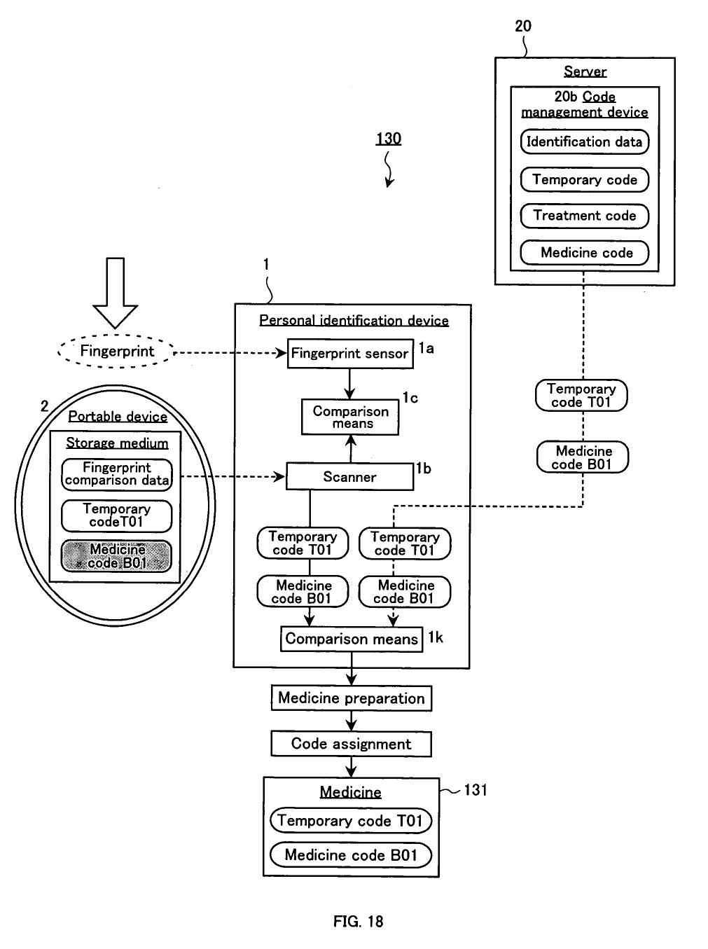

Next, the following describes the medicine preparation stage 130 with reference to FIG. 18. The storage medium 2 contains the temporary code (T01) that was set in the examination stage. The personal identification device 1 is installed in the medicine preparation room or at the medicine acceptance counter. When the medicine specified by the examination is prepared, this personal identification device 1 compares a fingerprint, detected by the fingerprint sensor 1a, with the fingerprint comparison data, read by the scanner 1c, via the comparison means 1b as described above for personal identification. In addition, the personal identification device 1 compares the temporary code, read by the scanner 1c, with the temporary code, sent from the server 20, via the comparison means 1k to confirm that the medicine is correct and performs the medicine preparation operation to create a medicine 131. This medicine 131 may be recorded in a storage medium, such as a seal or an IC chip, that is attached to the bag or cabinet in which the medicine 131 is stored, to allow the scanner 1c of the personal identification device 1 to read it for confirmation in the medicine distribution at a later time.

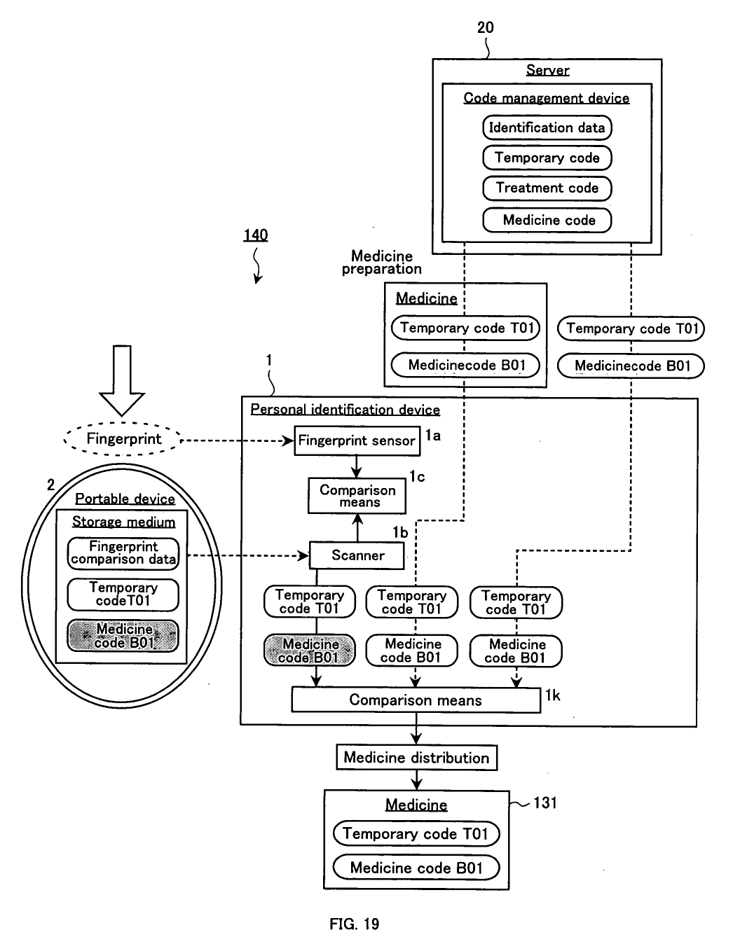

Next, the following describes the medicine counter-handover stage 140 with reference to FIG. 19. The storage medium 2 contains the temporary code (T01) that was set in the examination stage. The personal identification device 1 is installed in the medicine handover place or at the handover acceptance counter. When the medicine specified by the examination is handed over at the counter, this personal identification device 1 compares a fingerprint, detected by the fingerprint sensor 1a, with the fingerprint comparison data, read by the scanner 1c, via the comparison means 1b as described above for personal identification. In addition, the personal identification device 1 compares the temporary code, read by the scanner 1c, with the temporary code sent from the server 20 or with the temporary code attached to the bag or case in which the prepared medicine is stored, via the comparison means 1k to confirm that the medicine is correct before the medicine 131 is handed over.

When the medicine code and the treatment code are recorded in the storage medium 2, the comparison means 1k may check the temporary code as well as the medicine code and the treatment code. This comparison confirms the specified medicine and the treatment more reliably.

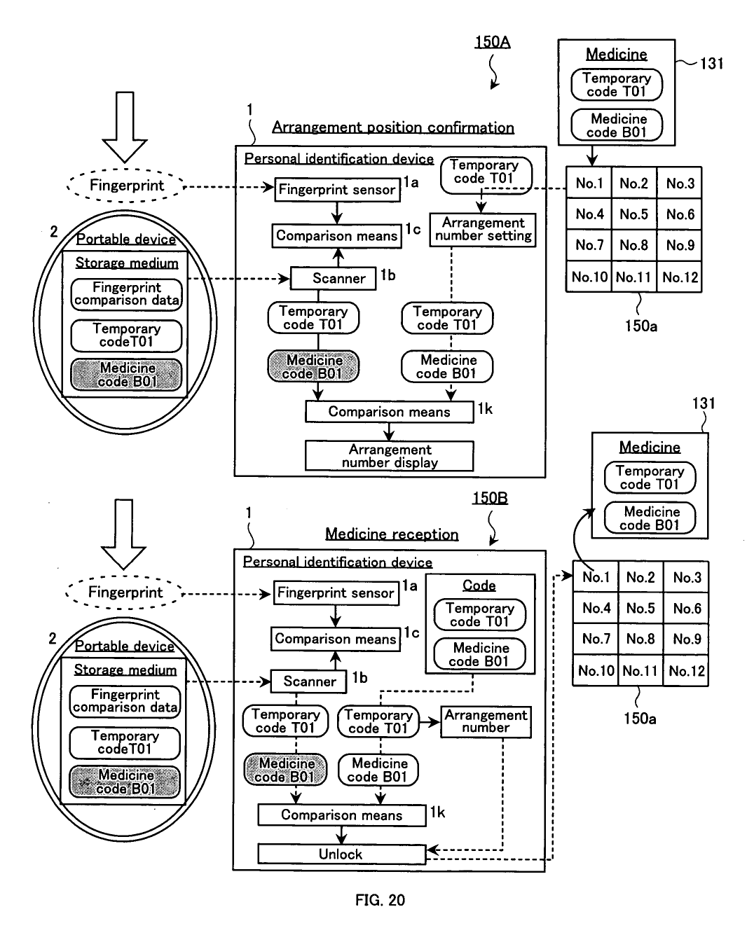

Next, the following describes the medicine reception stage 150 with reference to FIG. 20. This reception stage corresponds to the mode in which a user receives a medicine, prepared by the hospital in advance, with a number as the index.

The storage medium 2 contains the temporary code (T01) that was set in the examination stage. When the medicine specified by the examination is received, there are two stages: an arrangement position confirmation stage 150A in which the user confirms the number position where the prepared medicine is arranged and a medicine reception stage 150B in which the user receives the medicine arranged in the confirmed arrangement position.

In the arrangement position confirmation stage 150A, the personal identification device 1 is installed in the arrangement position confirmation place. This personal identification device 1 compares a fingerprint, detected by the fingerprint sensor 1a, with the fingerprint comparison data, read by the scanner 1c, via the comparison means 1b as described above for personal identification. In addition, the personal identification device 1 compares the temporary code, read by the scanner 1c, with the temporary code sent from the server 20 or with the temporary code attached to the bag or case in which the prepared medicine is stored, via the comparison means 1k and, when they are successfully compared, displays the number of the position where the medicine is stored.

As an example of medicine arrangement, the medicines are stored in a storage container 150a that are locked individually.

The user simply places the portable device over the personal identification device 1 to find the number of the container in which the medicine is stored.

Next, in the medicine reception stage 150B, the personal identification device 1 is installed in the reception place. This personal identification device 1 compares a fingerprint, detected by the fingerprint sensor 1a, with the fingerprint comparison data, read by the scanner 1c, via the comparison means 1b as described above for personal identification. In addition, the personal identification device 1 compares the temporary code, read by the scanner 1c, with the temporary code sent from the server 20 or with the temporary code attached to the bag or case in which the prepared medicine is stored, via the comparison means 1k and, when they are successfully compared, unlocks the storage container 150a to allow the user to receive the medicine 131.

The user can simply place the portable device over the personal identification device 1 to receive the medicine.

When the medicine code and the treatment code are recorded in the storage medium 2, the comparison means 1k may check the temporary code as well as the medicine code and the treatment code.

Next, the following describes an example of the application of the present invention to the medical field where user's history data is used for identifying the identity of the user.

In this application example, the user is identified by comparing the user's fingerprint with the fingerprint comparison data stored in the storage medium 2 and, in addition, by using the history of user's medical care as an index of comparison. The history of medical care, which differs among users, can be used to check whether user is authentic.

FIG. 21 shows an example in which user's history of the departments where user had a consultation is used as the medical care history. The personal identification device 1, installed in each department, stores the department code in the storage medium 2 for each medial care and, at the same time, records the department code for each user in the server 20. FIG. 21 shows an example in which the user had a consultation with departments P01, P05, and P07 in this order.

To identify the user's identity, the personal identification device 1 compares a fingerprint, detected by the fingerprint sensor 1a, with the fingerprint comparison data, read by the scanner 1c, via the comparison means 1b as described above for personal identification. In addition, the personal identification device 1 compares the department code history, read by the scanner 1c, with the department code history, sent from the server 20, via the comparison means 1k and, when they are successfully compared, identifies the user's identity.

The medical care history may be not only the information indicating the order of the departments with which the user had a consultation as described above but also the information indicating the combination of the departments, with which the user had a consultation, and their times of day. This method can be used for identifying user's identity even if the user had a consultation with few departments.

The embodiment of the present invention allows the user to obtain personal information simply by placing the fingerprint on the fingerprint sensor only for obtaining the fingerprint data, with no special awareness of, or consideration for, an operation to read various types of recording information such as fingerprint comparison data, identifying data, and personal information.

The embodiment of the present invention requires the fingerprint comparison data, which is used in fingerprint comparison, to be neither recorded on a card nor stored in the server, thus making the fingerprint comparison device simple and compact.

The embodiment of the present invention allows the portable device, on which the storage medium is mounted, to be easily formed according to the size of the user's finger, wrist, or ankle.

Furthermore, the portable device according to the present invention, which can be applied to the medical field, has the following special effects.

In the medical field, patients are physically handicapped in many cases, and elderly persons and children sometimes cannot communicate well. Therefore, when identifying a patient, it is desirable to provide an easy-to-operate personal identification device instead of requesting the patient to do a complicated personal identification operation.

For example, when a patient is in an unconscious state or physically handicapped, an identification device requesting the patient to do an operation, such as password entry, is not desirable. In addition, one of the problems with card-based personal identification is that a person does not always manage his or her card and, in a medical treatment site such as an operation site, a patient sometimes receives medical treatment unclothed and, in such a case, the patient cannot carry a medium such as a card.

In the medical field, there is a strong need for the prevention of the mix-up of medical cares, drips, and medication and, to minimize the possibility of mix-up, it is requested to always carry something for identification.

In a special environment such as the medical field described above, the present invention has a significant effect that a user can carry the device according to the present invention even in a situation where it is difficult for the user to carry a medium such as a card and, unless it is intentionally removed from the user and put on another user, there is no possibility of mix-up.

Because the device is easy to operate and a user other than an authentic user can perform the operation, the identification operation can be performed by a user other than the authentic user even in a situation when the user to be identified is in an unconscious state or physically handicapped.

### INDUSTRIAL APPLICABILITY

The personal identification device of the present invention is applicable to the sealing processing and the sign processing as well as to the medical field.

1. A personal identification device comprising a fingerprint sensor that detects a fingerprint; and a scanner that calls a storage medium mounted on a portable device worn on a finger, a wrist, or an ankle of a user for reading recording information stored on said storage medium; said fingerprint sensor and said scanner being integrally provided in a device main body of said personal identification device,
said personal identification device further comprising fingerprint comparison means for comparing fingerprint data of a user's finger detected by said fingerprint sensor with fingerprint comparison data read by said scanner from the storage medium of the portable device worn on the finger, the wrist, or the ankle of the user for identifying an identity between a holder of said storage medium and an authentic user via said fingerprint comparison.

2. The personal identification device according to claim 1, wherein said portable device has a shape of a ring or a bracelet.

3. The personal identification device according to claim 2, wherein said fingerprint sensor and said scanner are positioned on the device main body where the detection of a user's fingerprint by the fingerprint sensor and the reading of the storage medium mounted on the portable device worn by the user can be performed at the same time.

4. The personal identification device according to one of claims 1-3, further comprising display means in the device main body,
wherein, based on the fingerprint comparison, said scanner reads personal information from the recording information stored in said storage medium for display on said display means.

5. The personal identification device according to one of claims 1-3, wherein, based on the fingerprint comparison, said scanner reads identifying data, which identifies an individual, from the recording information stored in said storage medium and sends the identifying data to an external server to obtain personal information, which is identified by the identifying data, from the external server.

6. The personal identification device according to one of claims 1-3, wherein, based on the fingerprint comparison, the fingerprint data detected by said fingerprint sensor is sent to an external server to obtain personal information, which is identified by the fingerprint data, from the external server.

7. A system having a personal identification device, said system comprising:
the personal identification device according to one of claims 1-3; and an electronic sealing device that outputs seal data,
wherein, based on the fingerprint comparison, said personal identification device uses the scanner to read seal data from the recording information stored in said storage medium and sends the seal data to the electronic sealing device and
said electronic sealing device writes and reads the seal data, which has been read, to and from an external device.

8. The personal identification device according to claim 7, further comprising display means in the device main body,
wherein the seal data read from said storage g medium and/or the seal data read from the external device is displayed on said display means.

9. A system having a personal identification device, said system comprising:
the personal identification device according to one of claims 1-3; and a lock device that is unlocked by the comparison of identification data,
wherein, based on the fingerprint comparison, said personal identification device uses the scanner to read identification data from the recording information stored in said storage medium and sends the identification data to the lock device and
said lock device is unlocked by a comparison between the identification data, which has been read, with identification data stored in advance.
